(19) United States
(12) Patent Application Publication
(10) Pub. No.: US 2016/0285246 A1
(43) Pub. Date: Sep. 29, 2016

(54) PROTECTOR, ASSEMBLY OF WIRING MODULE WITH PROTECTOR AND ASSEMBLING METHOD THEREFOR

(71) Applicant: Sumitomo Wiring Systems, Ltd., Yokkaichi (JP)

(72) Inventors: Tetsuya Fujita, Yokkaichi (JP); Kaho Arai, Yokkaichi (JP)

(21) Appl. No.: 15/058,195

(22) Filed: Mar. 2, 2016

(30) Foreign Application Priority Data
Mar. 26, 2015 (JP) 2015-064162

(51) Int. Cl. H02G 3/04

(52) U.S. Cl. CPC H02G 3/0418; H02G 3/0437

(57) ABSTRACT

A protector (20) includes a protector main body (22) and a lid (40). The protector main body (22) includes a bottom plate (24) having a main body side hinge (27). Two first side walls (30) and two second side walls (32) project on opposite sides of the bottom plate (24). The lid includes a lid main body (41) and two auxiliary side walls (48). The lid main body (41) has a lid side hinge (46) and a bent part (45). The bent part (45) is arranged at a position corresponding to the main body side hinge (27) and the lid side hinge (46) is at a position displaced form the main body side hinge (27). Two auxiliary side walls (48) are arranged on opposite sides of the bent part (45) to close clearances formed between the first side walls (30) and the second side walls (32).

### BACKGROUND

1. Field of the Invention

The invention relates to a protector for covering a wiring material, to an assembly of wiring module and protector as well as to an assembly method therefor.

2. Description of the Related Art

Japanese Unexamined Patent Publication No. 2001-57720 discloses a protector for covering a U-turn portion of a harness. In Japanese Unexamined Patent Publication No. 2001-57720, the protector is composed of a protector main body and a lid cover. The protector main body is composed of a base for taking in and guiding the harness, and a reversing potion is bent from the tip of the base to guide the U-turn portion. The lid cover is composed of a main lid portion for closing the entire protector main body and a movable lid rotatable in a direction to close the reversing portion via a thin hinge on the tip of this main lid portion.

It is desired in some cases to provide a hinge on the bent portion of the protector main body of Japanese Unexamined Patent Publication No. 2001-57720 to facilitate mold removal. The hinge enables the protector main body to be molded in a state close to a linear state. Thus, mold removal is performed easily. Further, the bent portion can be formed by bending the hinge after molding. However, a protector main body that has a hinge also has clearances at a position on the side walls corresponding to the hinge.

Accordingly, the invention aims to close clearances formed at side walls at a position corresponding to a hinge when a protector main body is provided with the hinge.

### SUMMARY

A protector according to an aspect of the invention has a protector main body with a base having first and second base plates coupled via a main body side hinge. Two first side walls project substantially toward one principal surface side of the first base plate on substantially opposite side parts of the first base plate. Two second side walls are separated from the first side walls and project substantially in the substantially same projecting direction as the first side walls and are on substantially opposite side parts of the second base plate. The protector further has at least one lid. The lid includes a lid main body having first and second lid main body portions coupled via a lid side hinge and configured to at least partly close an opening between the two first side walls and an opening between the two second side walls. The main body side hinge and the lid side hinge are provided at positions displaced in an extending direction of the base with the protector main body and/or the lid united. A bent part is formed at a position of one of the base and the lid main body corresponding to the main body side hinge or the lid side hinge provided on the other of the base and the lid main body. Two auxiliary side walls are provided on substantially opposite side parts of the lid main body and at least partly close clearances formed adjacent the first and second side walls.

Accordingly, the base of the protector main body is configured so that the first and second base plates are coupled via the main body side hinge. Thus, the first side walls on the substantially opposite sides of the first base plate and the second side walls of the second base plate are separated and clearances are formed therebetween. On the other hand, the lid main body of the lid is configured so that the first and second lid main body portions are coupled via the lid side hinge, but the main body side hinge and the lid side hinge are provided at the positions displaced in the extending direction of the base with the protector main body and/or the lid united. The bent part is formed at the position of one of the base and the lid main body corresponding to the main body side hinge or the lid side hinge provided on the other of the base and the lid main body, and the two auxiliary side walls are formed on substantially opposite sides of the lid main body for closing the clearances formed between the two first side walls and the two second side walls. Thus, the clearances formed between the two first side walls and the two second side walls can be closed at least partly by the auxiliary side walls. In this way, the clearances formed at the side walls at the position corresponding to the main body side hinge can be closed at least partly when the protector main body is provided with the main body side hinge.

The lid main body may be provided to at least partly close the opening between the first side walls and the opening between the second side walls at a position distant from the base in a state where the bent part is provided on the second lid main body and arranged at a position corresponding to the main body side hinge and the lid side hinge may be arranged at a position displaced from the main body side hinge. Additionally, the auxiliary side walls may be provided on substantially opposite side parts of the bent part and may at least partly close the clearances formed between the first side walls and the second side walls with the base bent via the main body side hinge.

Accordingly, the auxiliary side walls are provided on the substantially opposite side parts of the bent part and the clearances formed between the two first side walls and the two second side walls can be at least partly closed by the auxiliary side walls. In this way, the clearances formed at the side walls at the position corresponding to the main body side hinge can be at least partly closed when the protector main body is provided with the main body side hinge.

The first and second side walls may include parts that project out with the base bent at the hinge, and the auxiliary side walls may be formed to project toward inner corner sides of the substantially opposite sides of the bent part. With this configuration, relatively large clearances are formed between the first side walls and the second side walls. Such relatively large clearances can be closed at least partly by the auxiliary side walls that project toward the inner corner sides of the substantially opposite side parts of the bent part.

The first and second side walls may include parts projecting inward with the base bent at the hinge, and the auxiliary side walls may project toward outer corners of the substantially opposite sides of the bent part. With this configuration, clearances are formed between the first side walls and the second side walls. However, such clearances can be closed at least partly by the auxiliary side walls that project toward the outer corners of the substantially opposite sides of the bent part.

The first and second side walls may include substantially inwardly projecting parts and substantially outwardly projecting parts with the base bent at the hinge. The lid may include an outer lid portion to be arranged on an outer side of the protector main body and/or an inner lid portion to be arranged on an inner side of the protector main body. The auxiliary side walls of the outer lid portion may project toward inner corners of the opposite sides of the bent part, and the auxiliary side walls of the inner lid portion may project toward outer corners of the opposite sides of the bent part. Accordingly, wiring materials can be accommodated on inner and outer sides of the protector main body, and clearances between the first side and second side walls can closed by the auxiliary side walls on each of the inner and outer sides of the protector main body.

The invention also relates to an assembly of a wiring module with the above-described protector and at least one bare conductor at least partly accommodated in a space enclosed by the base, the first and second side walls and the lid. Accordingly, the bare conductor can be accommodated in the protector while being least exposed to outside.

These and other features and advantages of the invention will become more apparent upon reading the following detailed description of preferred embodiments and accompanying drawings. It should be understood that even though embodiments are described separately, single features thereof may be combined to additional embodiments.

### BRIEF DESCRIPTION OF THE DRAWINGS

FIG. 1 is a perspective view showing a wiring module with protector according to an embodiment.

FIG. 2 is an exploded perspective view of the wiring module with protector.

FIG. 3 is a partial perspective view of the wiring module with protector.

FIG. 4 is a perspective view showing a protector main body portion.

FIG. 5 is a perspective view showing the protector main body portion.

FIG. 6 is a perspective view showing an outer lid portion.

FIG. 7 is a perspective view showing the outer lid portion.

FIG. 8 is a perspective view showing an inner lid portion.

FIG. 9 is a perspective view showing the inner lid portion.

FIG. 10 is a view showing a protector according to a modification.

### DETAILED DESCRIPTION

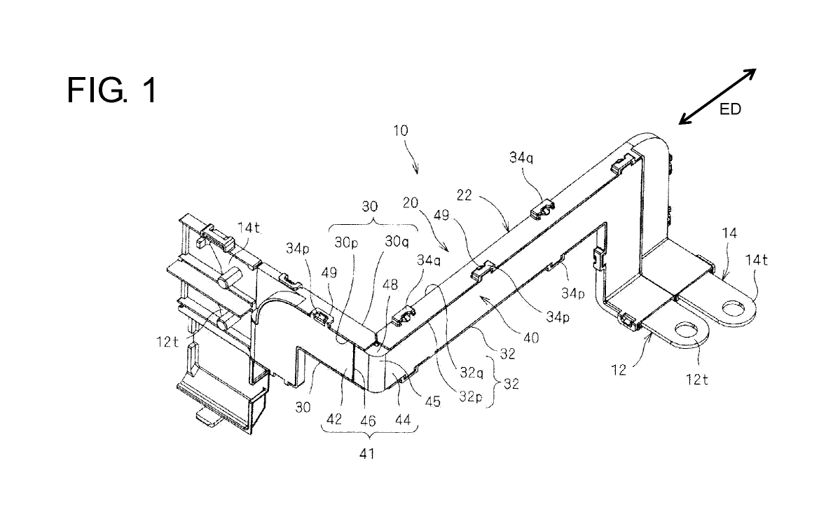

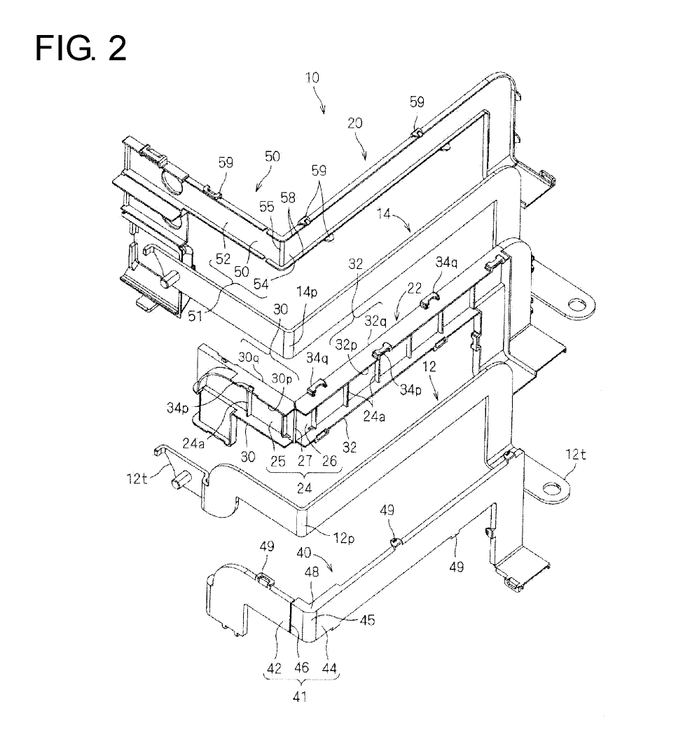

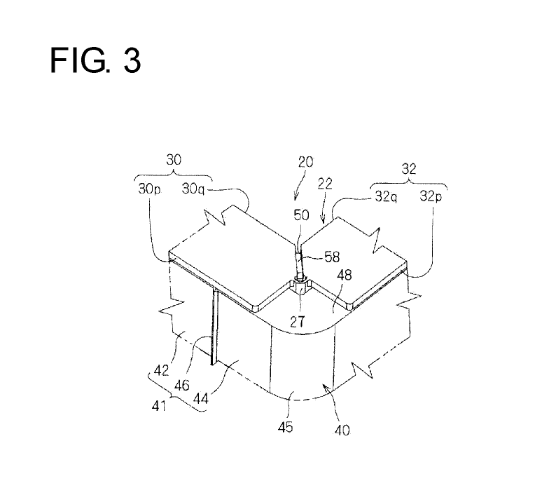

A wiring module in accordance with an embodiment of the invention is identified by the numeral 10 in FIGS. 1-10. The wiring module 10 includes bare conductors 12, 14 and a protector 20.

The bare conductors 12, 14 are wiring members for electrically connecting various electrical components (e.g. battery, inverter, motor) in a vehicle. The bare conductor 12, 14 is a thin strip with connecting end parts 12t, 14t for connection to other electrical devices on one or more intermediate parts and/or on substantially opposite ends thereof. An intermediate part of the bare conductor 12, 14 in an extending direction ED is bent into a shape substantially corresponding to a routing path in the vehicle. The intermediate part of the bare conductor 12, 14 in the extending direction ED is bent in a thickness direction at plural positions, and a part of each bare conductor 12, 14 between the two bends in the thickness direction is bent in a width direction substantially at a right angle at respective bent parts 12P, 14P. In this embodiment, description is centered on a part of the protector 20 for accommodating these bent parts 12P, 14P.

The bare conductor 12, 14 is formed by press-molding a metal plate material, such as copper, copper alloy, aluminum or aluminum alloy, into a shape substantially corresponding to the routing path in the vehicle. The bare conductor 12, 14 is exposed at least partly to outside without being coated. Such a bare conductor 12, 14 also is called a busbar. This bare conductor 12, 14 is insulated from outside by the protector 20.

Of course, the wiring members accommodated in the protector 20 need not be the bare conductors 12, 14 and may be insulated wires or the like.

The bare conductor 12 is accommodated at least partly in an outer side of the bent protector 20 and the bare conductor 14 is accommodated at least partly in an inner side of the protector 20. The bare conductors 12, 14 are formed in the substantially same shape bent substantially at the substantially same positions except for differences due to a difference in the path caused by the passage through the outer side or inner side of the protector 20, a difference in draw-out positions of the end parts, and the like.

The protector 20 includes a protector main body 22, at least one outer lid 40 and at least one inner lid 50. The protector 20 is formed into a long shape bent at the respective bent parts of the bare conductors 12, 14.

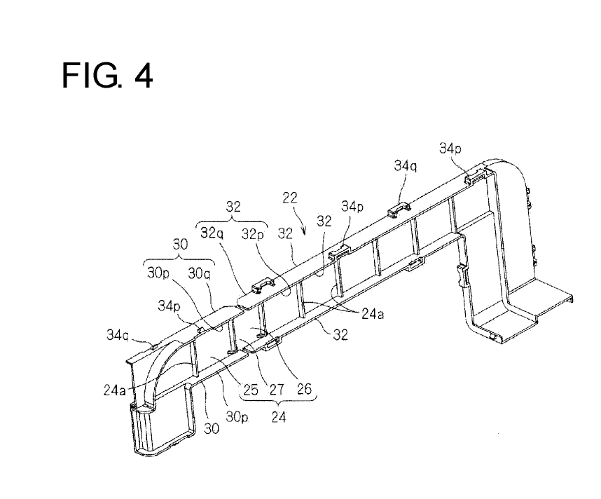

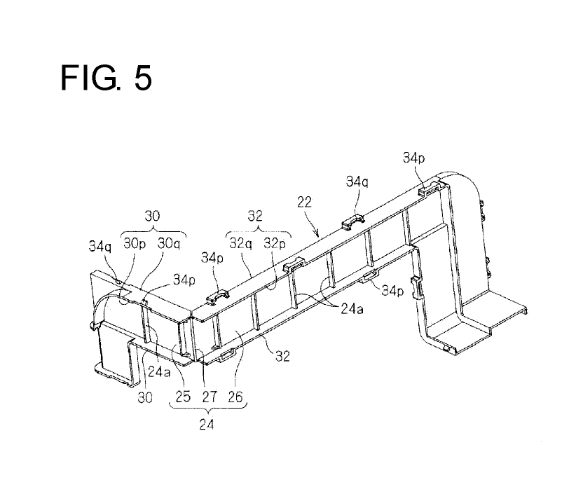

FIGS. 4 and 5 are perspective views of the protector main body 22. FIG. 4 shows a state before the protector main body 22 is bent at main body side hinge 27, and FIG. 5 shows a state where the protector main body 22 is bent at the main body side hinge 27.

As shown in FIGS. 1 to 5, the protector main body portion 22 is molded unitarily of resin or the like and includes a base 24, two first side walls 30 and two second side walls 32.

The base 24 includes a first bottom plate 25, a second bottom plate 26 and a main body side hinge 27.

The first bottom plate 25 has a shape substantially corresponding to parts of the bare conductors 12, 14 closer to one end than the bent parts 12P, 14P. The first bottom plate 25 has a thin strip shape bent in the width direction at an intermediate part in an extending direction thereof.

The second bottom plate 26 has a shape corresponding to the parts of the bare conductors 12, 14 closer to the other end than the bent parts 12P, 14P. The second bottom plate 26 has a thin strip shape bent in the width direction at an intermediate part in an extending direction thereof and bent in the thickness direction at another position.

Widths of the first and second bottom plates 25, 26 are substantially equal to or slightly larger than widths of the bare conductors 12, 14 in most parts. Of course, at an outer end part of the second bottom plate portion 26, the width of the second bottom plate portion 26 is about the same as the sum of the widths of the bare conductors 12, 14 since the bare conductors 12, 14 are drawn out to outside at positions different in the width direction thereof.

Note that the first and second bottom plate portions 25, 26 particularly are formed with one or more ribs 24a in the form of thin projections.

The main body side hinge 27 couples an end of the first bottom plate 25 to an end part of the second bottom plate 26. The main body side hinge 27 is a substantially linear part formed to be thinner than the first and second bottom plates 25, 26 and is easily bendable. More particularly, the main body side hinge 27 is provided at a position substantially corresponding to the bent parts 12P, 14P of the bare conductors 12, 14. Specifically, with the bare conductors 12, 14 accommodated in the protector 20, the bent part 12P is arranged on an outer corner of the main body side hinge 27 and the bent part 14P is arranged on an inner corner of the main body side hinge 27.

The first side walls 30 project from at least one principal surface side of the first bottom plate 25 on substantially opposite sides of the first bottom plate 25. To accommodate the bare conductors 12, 14 as described above, each of the first side walls 30 has a part 30p projecting out from one principal surface of the first bottom plate 25 and a part 30q projecting out the other principal surface of the first bottom plate 25 with the first and second bottom plates 25, 26 bent at the main body side hinge 27. Thus, an accommodation space for the bare conductor 12 is formed on the one principal surface side of the first bottom plate 25 and is enclosed at least partly by the first bottom plate 25 and the parts 30p of the first side walls 30. An accommodation space for the bare conductor 14 is formed on the other principal surface of the first bottom plate 25 and is enclosed at least partly by the first bottom plate 25 and the parts 30q of the first side walls 30.

The second side walls 32 project in substantially the same projecting direction as the first side walls 30 from opposite sides of the second bottom plate 26. Each of the second side walls 32 has a part 32p projecting out from one principal surface of the second bottom plate 26 and a part 32q projecting in from the other principal surface of the second bottom plate 26 with the first and second bottom plates 25, 26 bent at the main body side hinge 27. Thus, an accommodation space for the bare conductor 12 is formed on the other principal surface of the first bottom plate 25 and is enclosed at least partly by the second bottom plate 26 and the parts 32p of the second second side walls 32 is formed on the one principal surface of the second bottom plate 26. An accommodation space for the bare conductor 14 is formed on the other principal surface of the second bottom plate 26 and is enclosed by the second bottom plate 26 and the parts 32q of the second side walls 32.

The two first side walls 30 and the two second side walls 32 are separated at opposite sides of an extension of the main body side hinge 27. In a state where the first and second bottom plates 25, 26 are present on the substantially same plane, a clearance extending with the same width is formed between the parts 30p of the first side walls 30 and the parts 32p of the pair of second side walls 32, and a substantially V-shaped clearance extending from the main body side hinge 27 is formed between the parts 30q of the first side walls 30 and the parts 32q of the second side walls 32. The substantially V-shaped clearance is open at substantially 90°.

A substantially V-shaped clearance is formed between the parts 30p of the pair of first side walls 30 and the parts 32p of the pair of second side walls 32 When the first and second bottom plate portions 25, 26 are bent at a substantially right angle. This V-shaped clearance is open at an angle of substantially 90° from the main body side hinge 27. Conversely, the clearances between the parts 30q of the first side walls 30 and the parts 32q of the pair of second side walls 32 are closed and the parts 30q and 32p are in contact or tiny clearances are formed therebetween.

Note that side wall portions are formed on one side part and a widthwise central part on one principal surface of the outer end part of the second bottom plate 26, and side wall portions are formed on the other side part and the widthwise central part on the other principal surface of the outer end part of the second bottom plate portion 26. This causes the connecting end parts 12t, 14t of the bare conductors 12, 14 to be at least partly accommodated at positions different in the width direction thereof and drawn out to outside.

Locks 34p are formed on outward facing surfaces of the parts 30p of first side walls 30 and the parts 32p of the second side walls 32 for fixing the outer lid 40. Similarly, locks 34q are formed on outward facing surfaces of the parts 30q of the first side walls 30 and the parts 32q of the second side walls 32 for fixing the inner lid 50. The locks 34p, 34q are lock protrusions or lock receiving portions including holes for retaining and locking projection-like locks.

As described above, the protector main body 22 easily can be molded unitarily by being configured to be bent at the main body side hinge 27. Specifically, in the state where the first and second bottom plates 25, 26 are on substantially the same plane, the first side walls 30, the second side walls 32 and the locks 34p, 34q have shapes specified by planar or linearly observable surfaces when viewed in directions approximately orthogonal to the first and second bottom plates 25, 26. Thus, undercut parts can be reduced maximally if both directions substantially orthogonal to the first and second bottom plates 25, 26 are mold-releasing directions during molding. Therefore, the protector main body 22 easily can be molded unitarily.

In accommodating the bare conductors 12, 14 including the bent parts 12P, 14P, the bare conductors 12, 14 can be accommodated at least partly by bending the first and second bottom plate portions 25, 26 at the main body side hinge portion 27.

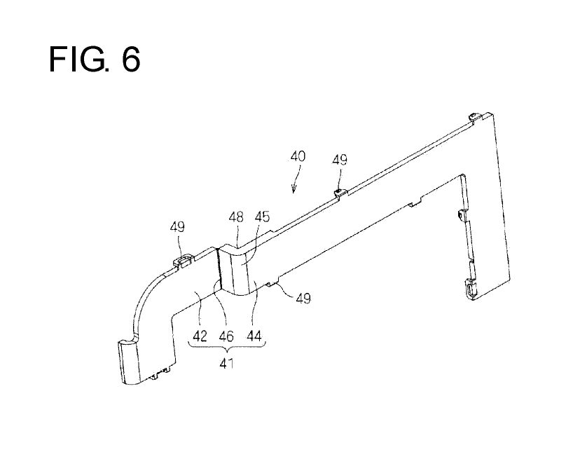

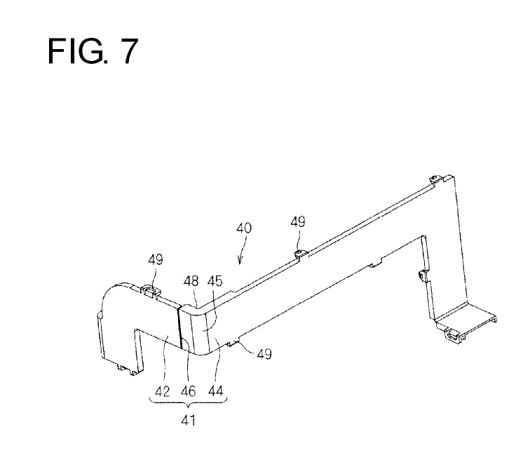

FIGS. 6 and 7 are perspective views showing the outer lid 40. FIG. 6 shows a state where the outer lid 40 is bent at a lid side hinge 46 and FIG. 7 shows a state where the outer lid 40 is extended straight at the lid side hinge 46.

As shown in FIGS. 1 to 3, 6 and 7, the outer lid 40 is molded unitarily of resin or the like and includes a lid main body 41 with a first lid main body portion 42, a second lid main body portion 44 and the lid side hinge 46.

The first lid main body portion 42 is substantially a long and narrow plate corresponding to a part of the first bottom plate 25 closer to the outer end than the main body side hinge 27.

The second lid main body portion 44 is substantially a long and narrow plate corresponding to a part of the first bottom plate portion 25 near the main body side hinge 27 and the second bottom plate 26. Note that an outer end of the first lid main body portion 42 is shaped to correspond to a part between the side walls on the outer end part of the second bottom plate 26. A part of the second lid main body portion 44 corresponding to the main body side hinge 27 has a bent part 45 with a specified bent shape bent in a thickness direction thereof. The bent part 45 preferably has a bent shape defining an angle of substantially at 90°.

The first and second lid main body portions 42, 44 are set to have the same widths as the first and second bottom plates 25, 26.

One end of the first lid main body portion 42 and one end of the second lid main body portion 44 are coupled via the lid side hinge 46. The lid side hinge 46 is a substantially linear part formed to be thinner than the first and second lid main body portion 42, 44 and is easily bendable. That is, the lid side hinge 46 continuously connects the first and second lid main body portions 42, 44.

The bent part 45 is arranged in the main body side hinge 27, and the lid side hinge 46 is provided at a position distant from the main body side hinge 27 toward the first bottom plate 25. Thus, the lid side hinge 46 is at a position displaced from the main body side hinge 27.

The first and second lid main body portions 42, 44 can at least partly close an opening between the first side walls 30 and/or an opening between the second side walls 32 at positions distant from the first and second bottom plates 25, 26.

Two auxiliary side walls 48 are provided on opposite sides of the bent part 45. The auxiliary side walls 48 project toward an inner corner from sides of the bent part 45 while forming a continuous angle. Projecting distances of the auxiliary side walls 48 are about the same as those of the first and second side walls 30, 32. Further, a distance between the outer surfaces of the auxiliary side walls 48 is equal to distances between the inner surfaces of the first side walls 30 and between the inner surfaces of the second side walls 32.

Locks 49 project on opposite sides of the first and second lid main body portions 42 and 44, and the locks 49 are lockable to the locks 34p.

With the first and second bottom plates 25, 26 bent at the main body side hinge 27, the locks 49 are locked and fixed to the locks 34p and the outer lid 40 is mounted on the protector main body 22. The first and second lid main body portions 42, 44 are arranged substantially along the first and second bottom plates 25, 26 and extend substantially straight by the first bottom plate 25 at the lid side hinge 46. Further, the auxiliary side walls 48 are arranged at inner sides of the parts 30p of the first side walls 30 of the first bottom plate 25 and the parts 32p of the second side walls 32 of the second bottom plate 26 to at least partly close the clearances between the parts 30p and/or between the parts 32p. Note that the auxiliary side walls 48 may be arranged at outer sides of the parts 30p of the first side walls 30 and the parts 32p of the second side walls 32.

As just described, a unitary outer lid 40 can be molded easily by being configured to be bent at the lid side hinge 46. Specifically, in a state where the first and second lid main body portions 42, 44 are bent substantially at a right angle via the lid side hinge 46, most parts of the first and second lid main body portions 42, 44 extend substantially along the same plane direction and the bent part 45, the auxiliary side walls 48, the locks 49 and the like have shapes specified by planar or linearly observable surfaces when viewed in directions approximately orthogonal to surfaces thereof. Thus, if both directions orthogonal to the first and second lid main body portions 42, 44 are mold-releasing directions during molding, undercut parts can be reduced maximally. Therefore, a unitary outer lid 40 can be molded easily.

The outer lid 40 can be mounted on the bent protector main body 22 by arranging the bent part 45 in the main body side hinge 27 and substantially extending the lid side hinge 46 straight.

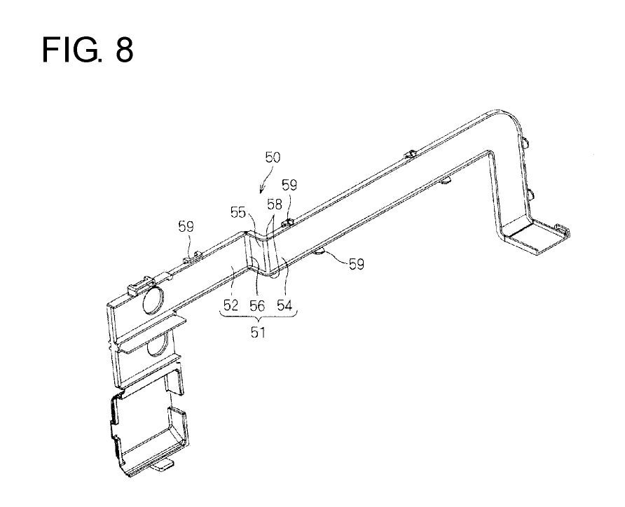

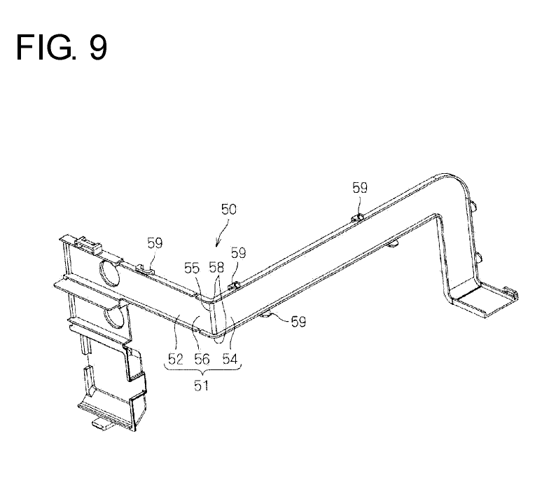

FIGS. 8 and 9 are perspective views showing the inner lid 50. FIG. 8 shows a state where the inner lid 50 is bent at a lid side hinge 56 and FIG. 9 shows a state where the inner lid 50 is extended straight at the lid side hinge 56.

As shown in FIGS. 1 to 3, 8 and 9, the inner lid 50 is molded unitarily of resin or the like and includes a lid main body 51 including a first lid main body portion 52, a second lid main body portion 54 and the lid side hinge 56.

The first lid main body portion 52 is a long and narrow plate corresponding to a part of the first bottom plate 25 closer to the outer end part than the main body side hinge 27. Note that an end lid for at least partly covering the connecting end parts 12t, 14t of the bare conductors 12, 14 is formed on an outer end part of the first lid main body 52.

The second lid main body portion 54 is a long and narrow plate corresponding to a part of the first bottom plate 25 near the main body side hinge 27 and the second bottom plate 26. Note that an outer end part of the first lid main body portion 52 is shaped to correspond to a part between the side walls on the outer end part of the other principal surface of the second bottom plate 26. A part of the second lid main body portion 54 corresponding to the main body side hinge 27 is formed into a specified bent part 55 bent in a thickness direction thereof. Here, the bent part 55 is formed to define an angle of substantially 90°.

The first and second lid main body portions 52, 54 have substantially the same widths as the first and second bottom plates 25, 26.

One end of the first lid main body portion 52 and one end of the second lid main body portion 54 are coupled via the lid side hinge 56. The lid side hinge 56 is a linear part formed to be thinner than the first and second lid main body portion 52, 54 and is easily bendable. The lid side hinge 56 continuously connects the first and second lid main body portions 52, 54.

The bent part 55 is arranged in the main body side hinge 27, and the lid side hinge 56 is provided at a position distant from the main body side hinge 27 toward the first bottom plate 25. Thus, the lid side hinge 56 is displaced from the main body side hinge 27.

The first and second lid main body portions 52, 54 can at least partly close the opening between the first side walls 30 and the opening between the second side walls 32 at positions distant from the first and second bottom plates 25, 26.

Auxiliary side walls 58 are provided on substantially opposite sides of the bent part 55. The auxiliary side walls 58 project toward an outer corner side from side edges of the bent part 55 that is continuous while forming an angle. Projecting distances of the auxiliary side walls 58 are about the same as those of the first and second side walls 30, 32. Further, a distance between the outer surfaces of the auxiliary side walls 58 is substantially equal to distances between the inner surfaces of the first side walls 30 and between the inner surfaces of the second side walls 32. Note that although two side walls are formed entirely on opposite side parts of the first and second lid main body portions 52, 54 in extending directions on the inner lid 50, this is not essential.

Locks 59 project on opposite sides of the first lid main body portion 52 and on opposite sides of the second lid main body portion 54 and are lockable to the locks 34q.

With the first and second bottom plates 25, 26 bent at the main body side hinge 27, the locks 59 are locked and fixed to the locks 34q and the inner lid 50 is mounted on the protector main body 22. The first and second lid main body portions 52, 54 are arranged along the first and second bottom plates 25, 26 and is extended substantially straight by the first bottom plate 25 at the lid side hinge 56. Further, the auxiliary side walls 58 are arranged at inner sides of the parts 30q of the first side walls 30 of the first bottom plate 25 and the parts 32q of second side walls 32 of the second bottom plate 26 to at least partly close the clearances between the parts 30q and between the parts 32q. Note that the auxiliary side walls 58 may be arranged at outer sides of the parts 30q of the first side walls 30 and the parts 32q of the second side walls 32.

As just described, the inner lid 50 easily can be molded unitarily by being configured to be bent at the lid side hinge 56. Specifically, in a state where the first and second lid main body portions 52, 54 are bent at a substantially at a right angle via the lid side hinge 56, most parts of the first and second lid main body portions 52, 54 extend substantially along the same plane, and the bent part 55, the auxiliary side walls 58, and the locks 59 have shapes specified by planar or linearly observable surfaces when viewed in directions approximately orthogonal to those. Thus, if both directions orthogonal to the first and second lid main body portions 52, 54 are mold-releasing directions during molding, undercut parts can be reduced maximally. Therefore, the inner lid portion 50 can be easily can be molded unitarily.

In mounting the inner lid 50 on the protector main body 22, the inner lid 50 can be mounted on the bent protector main body 22 by arranging the bent part 55 in the main body side hinge 27 and extending the lid side hinge 56 straight.

A method for manufacturing the wiring module with protector 10 initially includes molding the protector main body 22, the outer lid 40 and the inner lid 50. At this time, the protector main body 22 easily can be molded unitarily since the first and second bottom plates 25, 26 extend straight via the main body side hinge 27. The outer lid 40 and the inner lid 50 easily can be molded unitarily since the first lid main body portions 42, 52 and the second lid main body portions 44, 54 are bent at a substantially right angle at the lid side hinges 46, 56.

The first and second bottom plates 25, 26 are bent at a substantially right angle at the main body side hinge 27. In this state, the bare conductor 12 is arranged in the space enclosed by the first and second bottom plates 25, 26, the parts 30p of the first side walls 30 and the parts 32p of the second side walls 32. Thereafter, the locks 49 are locked to the locks 34p and the outer lid 40 is mounted on the protector main body 22. At this time, the clearances between the parts 30p of the first side walls 30 and between the parts 32p of the second side walls 32 formed by bending at the main body side hinge 27 are closed by the auxiliary side walls 48.

Further, the bare conductor 14 is arranged in the space enclosed by the first and second bottom plates 25, 26, the parts 30q of the pair of first side walls 30 and the parts 32q of the second side walls 32. Thereafter, the locks 59 are locked to the locks 34q and the inner lid 50 is mounted on the protector main body 22. At this time, the clearances between the parts 30q of the first side walls 30 and between the parts 32q of the second side walls 32 formed by bending at the main body side hinge 27 are closed by the auxiliary side walls 58.

According to the wiring module with protector 10 and the protector 20 configured as described above, the bottom plate 24 of the protector main body 22 is configured so that the first and second bottom plates 25, 26 are coupled via the main body side hinge 27. Thus, the protector main body 22 easily can be molded unitarily.

Further, if the above configuration is adopted, the first side walls 30 on the opposite side parts of the first bottom plate 25 and the second side walls 32 of the second bottom plate 26 are separated and the clearances are formed therebetween.

On the other hand, for the outer lid 40 and the inner lid 50, the lid main body portions 41, 51 are configured so that the first lid main body portions 42, 52 and the second lid main body portions 44, 54 are coupled via the lid side hinges 46, 56, but the specified bent parts 45, 55 are formed on the second lid main body portions 44, 54 and the lid side hinges 46, 56 are provided at the positions displaced from the main body side hinge 27. The auxiliary side walls 48, 58 are provided on the bent part 45, 55 and the clearances formed between the first side walls 30 and the second side walls 32 are closed by the pairs of auxiliary side walls 48, 58.

In this way, the clearances formed between the first side walls 30 and the second side walls 32 can be closed at the position corresponding to the main body side hinge 27 when the protector main body 22 is provided with the main body side hinge 27.

Note that the outer lid 40 and the inner lid 50 easily can be molded unitarily since the lid side hinges 46, 56 are provided.

If the first side walls 30 and the second side walls 32 include the outwardly projecting parts 30p, 32p with the first and second bottom plates 25, 26 bent at the main body side hinge 27, clearances also are formed between these parts 30p, 32p. The clearances can be closed by the auxiliary side walls 48 that project toward the inner corners of the opposite sides of the bent part 55 of the outer lid 40.

The first side walls 30 and the second side walls 32 include the inwardly projecting parts 30q, 32q with the first and second bottom plates 25, 26 bent at the main body side hinge 27, and clearances are formed between these parts 30q, 32q. Such clearances can also be closed by the auxiliary side walls 58 formed to project toward outer corners of the opposite side parts of the bent part 55 of the inner lid 50.

By also using the above configuration, the clearances formed between the first side walls 30 and the second side walls 32 at the opposite sides can be closed by the auxiliary side wall portions 48, 58 while the bare conductors 12, 14 are accommodated on the opposite sides of the protector main body 22.

As just described, in the configuration in which the bare conductors 12, 14 are accommodated in the protector 20 by at least partly closing the respective clearances by the auxiliary side walls 48, 58, the exposure of the bare conductors 12, 14 to outside can be prevented as much as possible.

Note that, in the above embodiment, the first side walls and the second side walls may project only on the one principal surface of the bottom plate and one of the bare conductors 12, 14 and the one of the outer lid 40 and the inner lid 50 may be omitted.

Further, a plurality of wiring materials may be accommodated on the one principal surface side of the bottom plate 24.

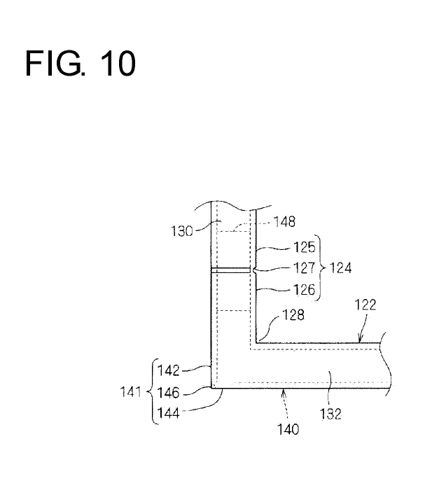

Further, although the outer lid portion 40 and the inner lid portion 50 are formed with the bent parts 45, 55 in the above embodiment, a bent part 128 may be formed on a protector main body 122 corresponding to the protector main body 22 as in a modification shown in FIG. 10. That is, although the lid side hinges 46, 56 of the outer lid 40 and the inner lid 50 are displaced from the bent position of the protector 20 in the above embodiment, an example in which a main body side hinge 127 of the protector main body 127 is displaced from the bent position of the protector is described in this modification.

In this modification, the protector main body 122 includes a bottom plate 124 having a first bottom plate 125 and a second bottom plate 126 coupled via the main body side hinge 127, two first side walls 130 projecting from one principal surface at opposite sides of the first bottom plate 125 and two second side walls 132 projecting from the one principal surface from opposite side parts of the second bottom plate 126.

The second bottom plate 126 is formed with a bent part 128 having a specified shape bent at a right angle in a thickness direction thereof. The bent part 128 is arranged at a position substantially corresponding to a lid side hinge 146 to be described later with the protector main body 122 and a lid 140 united.

Further, the lid 140 includes a lid main body 141 having a first lid main body portion 142 and a second lid main body portion 144 coupled via the lid side hinge 146.

The main body side hinge 127 and the lid side hinge 146 are provided at positions displaced in an extending direction of the bottom plate 124 with the protector main body 122 and the lid 140 united. Here, the lid side hinge 46 is arranged in the bent shape 128.

Further, the auxiliary side walls 148 for preventing clearances between the first side walls 130 and the second side walls 132 are formed on opposite sides of the lid main body 141. Specifically, the auxiliary side walls 148 (particularly substantially in the form of rectangular plates) are formed on opposite sides of the first lid main body portion 142.

Also by this modification, the clearances formed between the first side walls 130 and the second side walls 132 by forming the protector main body 122 with the main body side hinge 127 can be closed by the auxiliary side walls 148.

The invention has been described and illustrated with respect to one embodiment. However, numerous unillustrated modifications can be made without departing from the scope of this invention as defined by the claims.

### Reference Signs

10 wiring module with protector
12, 14 bare conductor
12P, 14P bent part
20 protector
22, 122 protector main body
24, 124 bottom plate portion (base plate portion)
25, 125 first bottom plate
26, 126 second bottom plate
27, 127 main body side hinge
30, 130 first side wall
32, 132 second side wall
40 outer lid
41, 51, 141 lid main body
42, 142 first lid main body portion
44, 144 second lid main body portion
45, 55 bent part
46, 56 lid side hinge
48, 58, 148 auxiliary side wall
50 inner lid
128 bent part
140 lid

What is claimed is:

1. A protector (20), comprising:
a protector main body (22; 122) including a base (24; 124) having a first base plate (25; 125) and a second base plate (26; 126) coupled via a main body side hinge (27; 127), two first side walls (30; 130) projecting from one principal surface of the first base plate (25; 125) on substantially opposite side parts of the first base plate (25; 125), and two second side walls (32; 132) separated from the first side walls (30; 130) and projecting in substantially the same projecting direction as the first side walls (30; 130) on substantially opposite side parts of the second base plate (26; 126); and
at least one lid (40; 140) including a lid main body (41; 51; 141) having a first lid main body portion (42; 142) and a second lid main body portion (44; 144) coupled via a lid side hinge (46; 56) and configured to at least partly close an opening between the first side walls (30; 130) and an opening between the second side walls (32; 132), wherein:
the main body side hinge (27; 127) and the lid side hinge (46; 56) are provided at positions displaced in an extending direction of the base plate (24; 124) with the protector main body (22; 122) and the lid (40; 140) united;
a specified bent part is formed at a position of one of the base plate (24; 124) and the lid main body (41; 51; 141) corresponding to the main body side hinge (27; 127) or the lid side hinge (46; 56) provided on the other of the base plate (24; 124) and the lid main body (41; 51; 141); and
two auxiliary side walls (48; 58; 148) configured to at least partly close clearances formed between the pair of first side walls (30; 130) and the pair of second side walls (32; 132) are provided on substantially opposite side parts of the lid main body (41; 51; 141).

2. The protector of claim 1, wherein:
the lid main body (41; 51; 141) is provided to close the opening between the first side walls (30; 130) and the opening between the pair of second side walls (32; 132) at a position distant from the base plate (24; 124) in a state where the bent part (45; 55) is provided on the second lid main body (41; 51; 141) and arranged at a position corresponding to the main body side hinge and the lid side hinge is arranged at a position displaced from the main body side hinge; and
the auxiliary side walls (48; 58; 148) are provided on substantially opposite sides of the bent part (45; 55) and close the clearances formed between the first side walls (30; 130) and the second side walls (32; 132) with the base plate (24; 124) bent via the main body side hinge (27; 127).

3. The protector of claim 2, wherein:
the first side walls (30; 130) and the second side walls (32; 132) include parts projecting out with the base plate (24; 124) bent at the hinge; and
the auxiliary side walls (48; 58; 148) are formed to project toward inner corner sides of the substantially opposite side parts of the bent part (45; 55).

4. The protector of claim 2, wherein:
the first side walls (30; 130) and the second side walls (32; 132) include parts projecting in with the base plate (24; 124) bent at the hinge; and
the auxiliary side walls (48; 58; 148) project toward outer corners of the substantially opposite side parts of the bent part (45; 55).

5. The protector of claim 2, wherein:
the first side walls (30; 130) and the second side walls (32; 132) include inwardly projecting parts and outwardly projecting parts with the base plate (24; 124) bent at the hinge;
the lid (40; 140) includes an outer lid portion (40) to be arranged on an outer side of the protector main body (22; 122) and an inner lid (50) to be arranged on an inner side of the protector main body (22; 122);
the auxiliary side walls (48; 58; 148) of the outer lid (40) are formed to project toward inner corner sides of the substantially opposite side parts of the bent part (45; 55); and
the auxiliary side walls (48; 58; 148) of the inner lid (50) are formed to project toward outer corners of the substantially opposite side parts of the bent shape part (45; 55).

6. An assembly of a wiring module (10) with protector (20), comprising:
the protector of claim 1; and
at least one bare conductor (12; 14) at least partly accommodated in a space enclosed by the base plate portion (24; 124), the pair of first side wall portions (30; 130) and the pair of second side wall portions (32; 132) and the lid portion (40; 140).
